(19) United States
(12) Patent Application Publication
(10) Pub. No.: US 2018/0133638 A1
(43) Pub. Date: May 17, 2018

(54) AIR FILTER ASSEMBLY

(71) Applicant: Todd John Shafer, Ashland, OH (US)

(72) Inventor: Todd John Shafer, Ashland, OH (US)

(21) Appl. No.: 15/352,711

(22) Filed: Nov. 16, 2016

(51) Int. Cl. B01D 46/00; B01D 46/10

(52) U.S. Cl. CPC B01D 46/0028; B01D 46/0005; B01D 46/0035; B01D 2279/65; B01D 2275/10; B01D 2279/35; B01D 46/10

(57) ABSTRACT

An improved air filter assembly for removing particles from air flow across the filter assembly utilizing a tackifier material in combination with an antibacterial substance. The air filter assembly comprises a peripheral frame adapted to be supported in communication with an intake opening in a residential return air duct; and a filter media mounted within the frame for removing particulate from air flowing from an upstream side of the filter assembly to a downstream side of the air filter assembly. The downstream side of the filter media comprises a layer of filter media treated with the tackifier material or a sticky oil and the antimicrobial substance.

### BACKGROUND

The present invention generally relates to an improved air filter assembly for removing solid material or contaminants from an air stream. More particularly, this invention relates to an improved apparatus for removing or filtering solid contaminants from an air stream which is subjected to heat exchange to produce air useful for heating or cooling purposes in a residential context.

Many residential housing units and other buildings are heated or cooled by the circulation of air through a heating furnace or cooling unit, where the air is warmed or cooled by heat exchange. The air is then passed to the room or rooms which it is desired to heat or cool.

In order to maintain efficient heating and cooling operation, one or more disposable furnace filters are placed in the path of the air flow which is subjected to heat exchange in the heating/cooling unit to remove solid material or contaminants from the air. Without such filters, the heat exchange surfaces of the heating and cooling unit would tend to become coated with such solid material and become less effective. Moreover, contaminants such as microbes, bacteria, pollen, dust, dust mites, tobacco smoke, mold spores, pet allergens, and smog particles are recycled through the system and back into the areas which are desired to be heated or cooled; making for unpleasant air quality within the residence.

Conventional filters presently found on the market are mediocre at best. These filters quickly lose their ability to effectively filter the passing air and thus need to be frequently changed. Moreover, these filters tend to be unsuccessful at removing all of the contaminates that may be found in household air.

Thus, for the foregoing reason, there is a need for a filter assembly that will provide an efficient means of removing contaminates from household air such as bacteria, microbes, pollen, dust, dust mites, tobacco smoke, mold spores, pet allergens, and smog particles.

### SUMMARY

In accordance with the invention, a filter assembly is provided which boasts the ability to provide an air filter for existing heating/cooling units that is more proficient than current disposable filters at removing particulates, from the airflow within the duct system including bacteria, microbes, fungus pollen, dust, dust mites, tobacco smoke, mold spores, pet allergens and other airborne particles, which affect the quality of the air. The invention provides a filter that is economical, safe and efficient.

The invention generally comprises a filter assembly for removing particles from air flow across the filter assembly from an upstream side to a downstream side, the filter assembly comprising: (a) a peripheral frame adapted to be supported in communication with an intake opening in a residential return air duct; and (b) a filter media mounted within the frame for removing particulate from air flowing from the upstream side of the filter assembly to the downstream side of the filter assembly. The downstream side of the filter media comprising a layer of filter media treated with a tackifier material. In a version of the invention, the tackifier material is an oil based material for increasing the tack, or the stickiness of the filter media.

In a version of the invention, an antibacterial substance is added to the filter media in order to kill and inhibit the growth of bacteria, microbes and fungus. Ideally, the antibacterial substance contains the organic compound triclosan.

In versions of the invention, the filter media may be a synthetic material, polyester material, fiberglass material, carbon material or any material that provides a medium for removing particulates from the airflow.

These and other features of the present invention will become readily apparent upon further review of the following specification and drawings.

### BRIEF DESCRIPTION OF THE DRAWINGS

These and other features, aspects, and advantages of the present invention will become better understood with regard to the following description and accompanying figures where:

FIG. 1 is a downwind side perspective view of a version of the invention;

FIG. 2 is an upwind side perspective view of the version shown in FIG. 1;

FIG. 3 is a exploded view of the version shown in FIG. 1;

FIG. 4 is an up-close view of the tackifier layer taken from FIG. 3;

FIG. 5 is a sectional view taken along line 5-5 in FIG. 1;

FIGS. 6A and 6B is a published product sheet relating to an example antibacterial compound which contains triclosan;

FIGS. 7A and 7B is a material safety data sheet relating to an example antibacterial compound which contains triclosan; and

FIG. 8 is a testing and analysis report of a version of the invention.

### DETAILED DESCRIPTION

Referring now to the figures wherein the showings are for purposes of illustrating a preferred version of the invention only and not for purposes of limiting the same, the present invention is a residential filter assembly with a tackifier layer for providing an improved filtration device, efficiently removing contaminate from airflow; thereby increasing the quality of the circulating air within a household residence. Moreover, in a version of the invention, the filter assembly further comprises a layer of antibacterial/antimicrobial agent. The combination of the tackifier layer and the antibacterial agent provides a superior air filter unlike the prior art.

The following detailed description is of the best currently contemplated modes of carrying out exemplary versions of the invention. The description is not to be taken in the limiting sense, but is made merely for the purpose illustrating the general principles of the invention, since the scope of the invention is best defined by the appended claims.

Various inventive features are described below that can each be used independently of one another or in combination with other features.

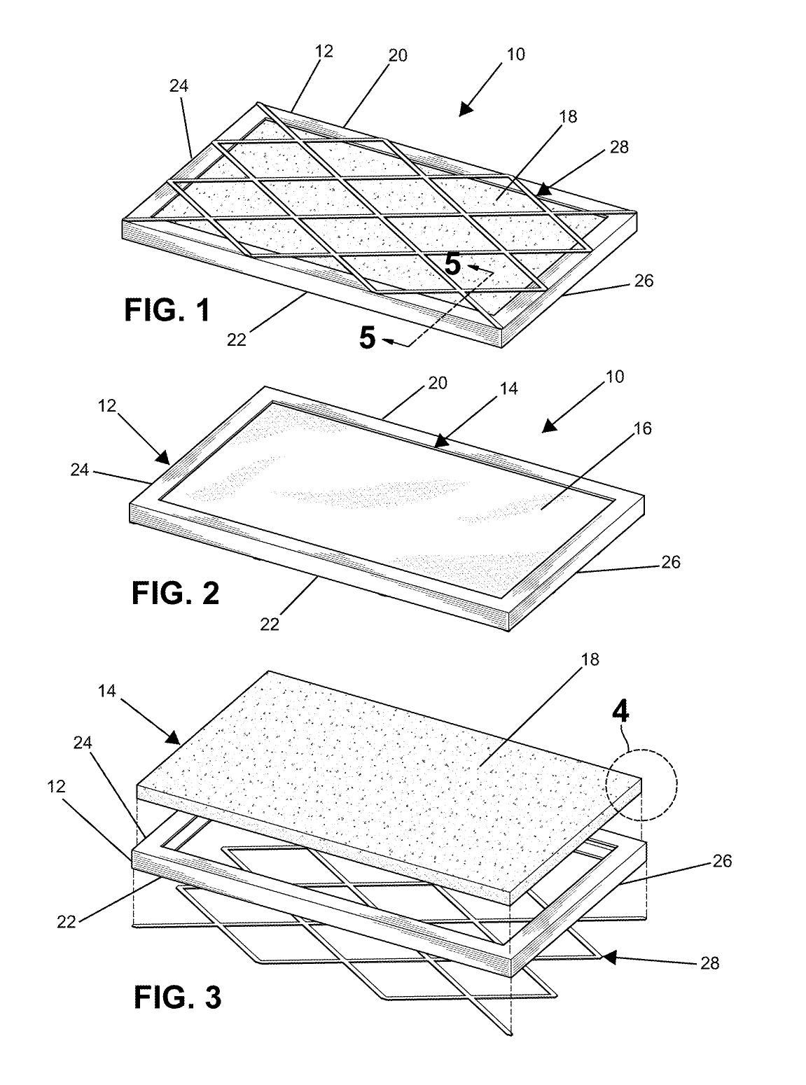

With reference to the figures FIG. 1-FIG. 5, a description of a version of the invention will be provided. FIG. 1 is a downwind side perspective view of the filter assembly 10 and FIG. 2 is an upwind side perspective view of the filter assembly 10 while in an assembled configuration. The filter assembly 10 may be located either upstream or downstream from the heat exchange heating/cooling unit, with upstream being preferred in order to maximize the protection of the heat exchange heating/cooling unit by the filter assembly 10.

Filter assembly 10 generally comprises a peripheral frame 12 and a filter media 14 mounted within the peripheral frame 12. The filter media 14 having an upwind side 16 and a downwind side 18. The filter media 14 is for removing particulate from air flowing from the upwind side 16 to the downwind side 18 of the filter assembly 10.

The peripheral frame 12 comprises a top member 20, a bottom member 22, and side members 24 and 26 which form a rectangular frame adapted to be supported in communication with an intake opening in a residential return air duct or within the airflow of a heating/cooling unit as known in the residential heating and cooling art. The peripheral frame 12 can be made of any material that provides a rigid structure to the filter assembly 10 such as cardboard, wood, plastic, composites, etc. Also, the shape of the filter assembly 10 provided by the peripheral frame 12 can be any shape and size as known in the heating and cooling industry regarding disposable filters. Thus, the specific dimensions may vary according to alternative heating/cooling unit applications. For example, the dimensions of the filter assembly 10 and peripheral frame can be 16 in.×20 in.×1 in., fitting a standard sized air duct return air slot. Alternatively, the dimension can be 20 in.×20 in.×1 in., fitting other sized return air ducts.

Optionally, the filter assembly 10 may include a screening pattern 28 which further provides structure and rigidity of the filter assembly 10 in conjunction with the peripheral frame 12. Ideally, the screening pattern is positioned adjacent either the downwind side 18 or the upwind side 16 or both sides of the filter media 14 connecting the peripheral frame 12 top member 20, bottom member 22, and side members 24 and 26. The screening pattern 28 can be made of any material that further provides structure, such as cardboard, wood, and plastic or something of similar constructions as the peripheral frame 12.

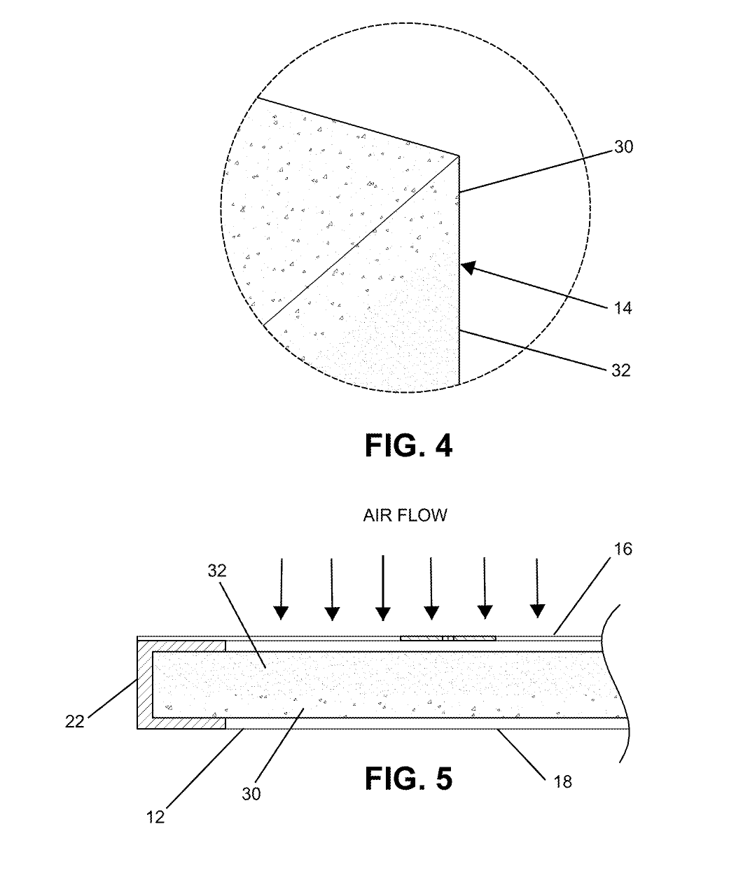

Referring to FIG. 4 and FIG. 5, the filter media 14 can be made of a synthetic material, polyester material, fiberglass material, carbon material, hog hair or any other media that acts as an air filter for removing particulate from flowing air. In particular, the filter media 14 is provided with a tackified layer 30 that is treated with a tackifier material in order to create a sticky layer within the filter media 14. Generally, tackifiers are chemical compounds used in formulating adhesives to increase the tack, the stickiness of the surface of the adhesive. This layer is positioned near the downwind side 18 within the filter media 14. Thus, leaving an upwind layer 32 which has not been treated with a tackifier material and a downwind tackified layer 30 which has been treated with a tackifier material. The tackifier material can be any material that is known to increase the tack or stickiness of the filter media within the tackified layer 30. Preferably, the tackifier material applied to the filter media 14 is oil based or a sticky oil or equivalent. The tackifed layer 30 provides an increase in filter efficiency regarding removing contaminates from the airflow moving from the upwind side 16 of the filter media 14 to the downwind side 18 of the filter media 14.

In a version of the invention, an antimicrobial/antibacterial substance is added to the tackified layer 30 in order to filter out and eliminate all types of bacteria, microbes, and fungus passing through the filter assembly 10. It will be known that the antimicrobial/antibacterial substance can be treated to a separate layer of the filter media 14, upstream from the tackified layer 30; however, ideally both the tackifier material and the antibacterial substance is applied to the same layer 30 in combination. The antibacterial substance can be any substance, compound, or agent which is known to kill or inhibit the growth of bacteria, microorganism, and/or fungus.

Ideally, the antibacterial substance contains at least 1% triclosan by weight. Triclosan is an antibacterial and antifungal organic compound agent widely used in the soaps and cleaning supplies. In more detail, triclosan is a chlorinated aromatic compound that has ether and phenol groups. Such phenols reportedly often show anti-bacterial properties. Triclosan may be used in soaps, deodorants, toothpastes mouthwashes, and cleaning supplies and is incorporated in an increasing number of consumer products, such as kitchen utensils, toys, bedding, socks, and trash bags. It has been reportedly shown as effective in reducing and controlling bacterial contamination on the hands and on treated products.

Triclosan is disclosed as being useful as an antimicrobial agent in various formulations in the following patents: EP1460089; U.S. Pat. No. 6,045,813; U.S. Pat. No. 6,955,827; U.S. Pat. No. 6,224,579; U.S. Pat. No. 6,207,139; U.S. Pat. No. 6,596,657; U.S. Pat. No. 6,780,799; U.S. Pat. No. 3,903,007; U.S. Pat. No. 3,987,797; U.S. Pat. No. 4,024,871; U.S. Pat. No. 5,378,540; U.S. Pat. No. 6,106,505; U.S. Pat. No. 6,083,208; US 2004/0185250; US 2006/0091034; US 2002/0028229; WO 96/38528; U.S. Pat. No. 4,020,100; EA 0099177.

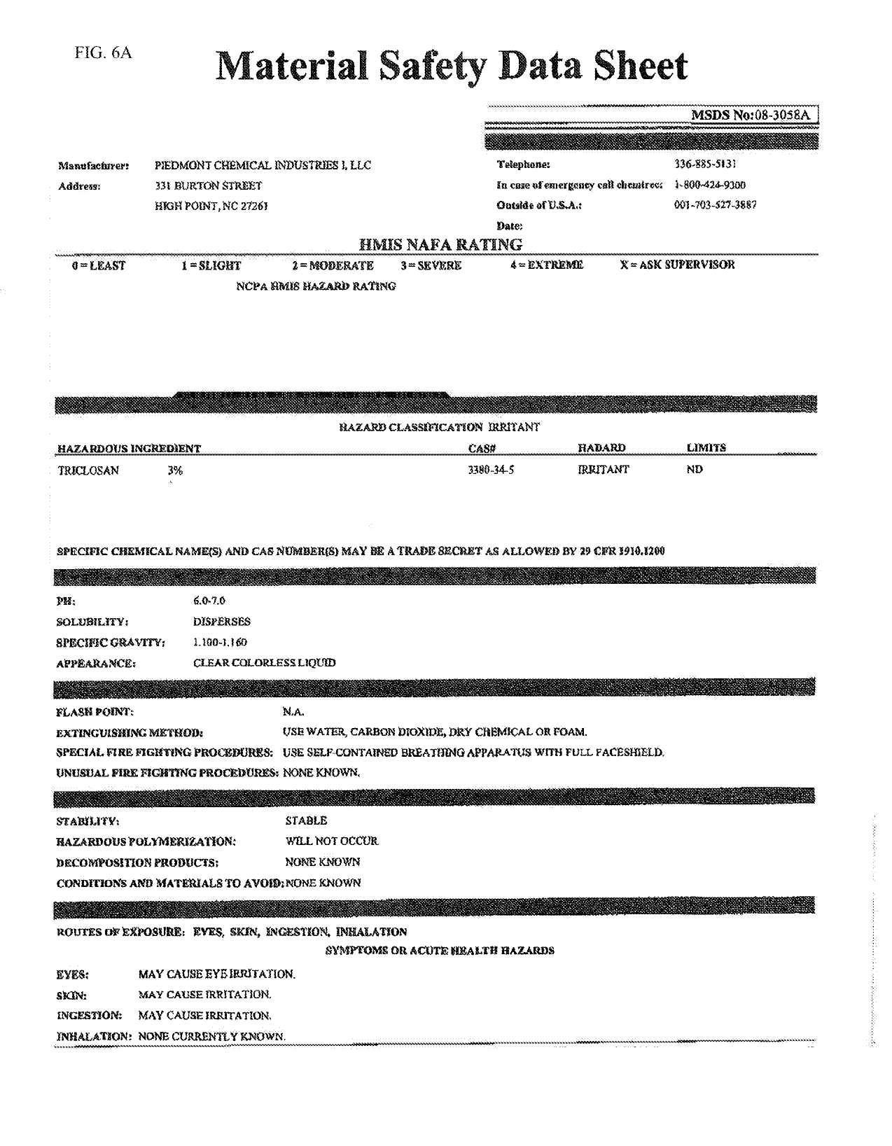

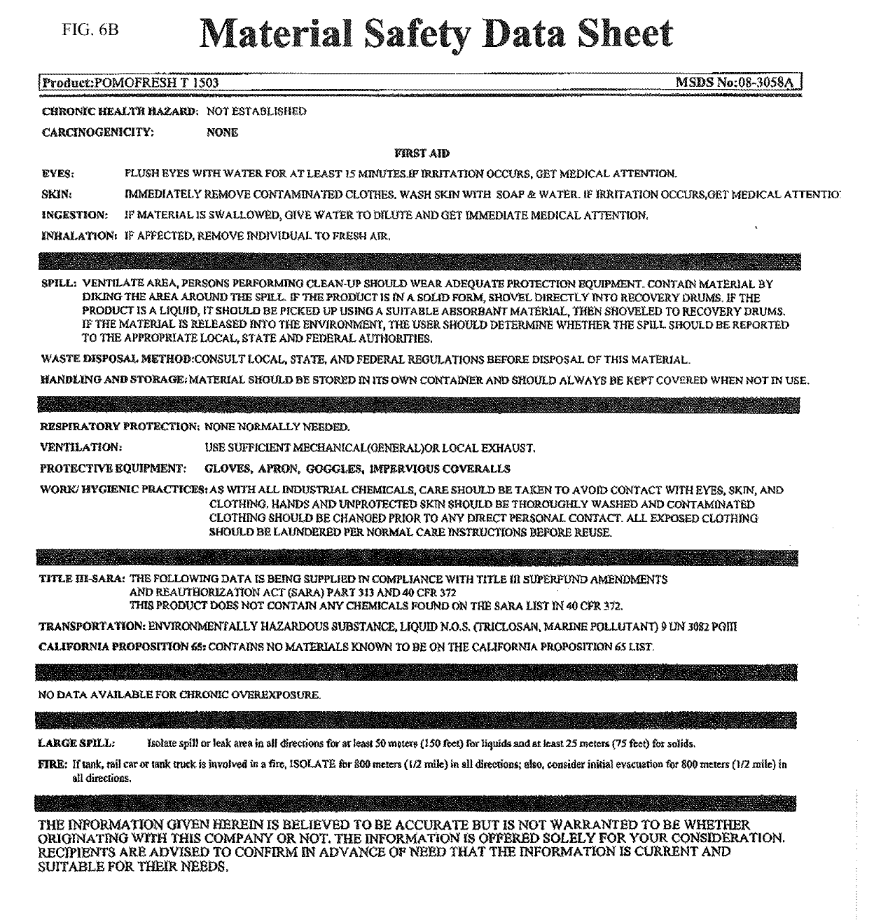

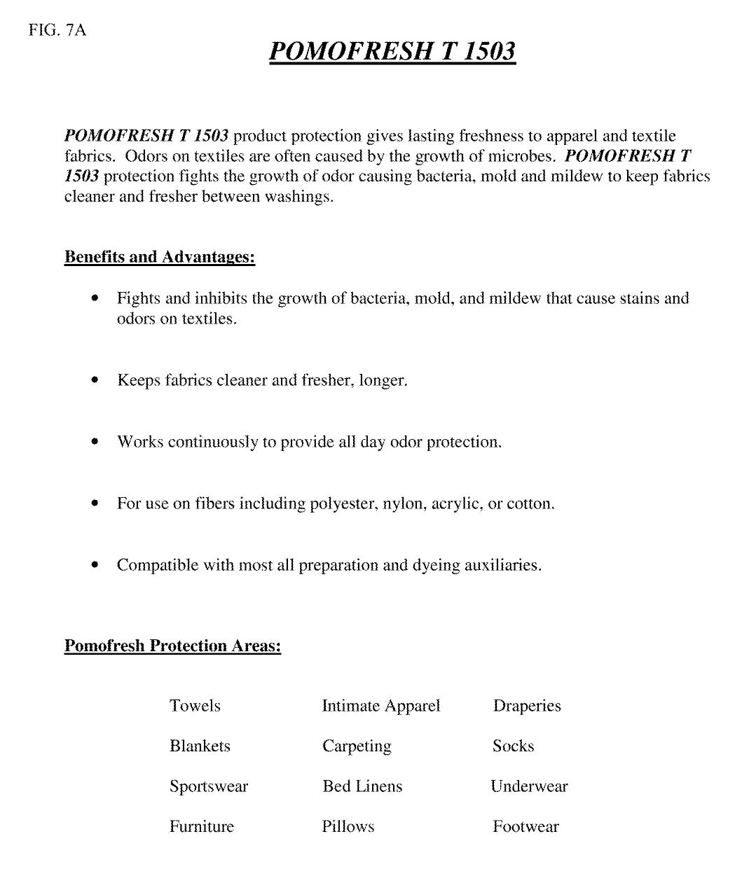

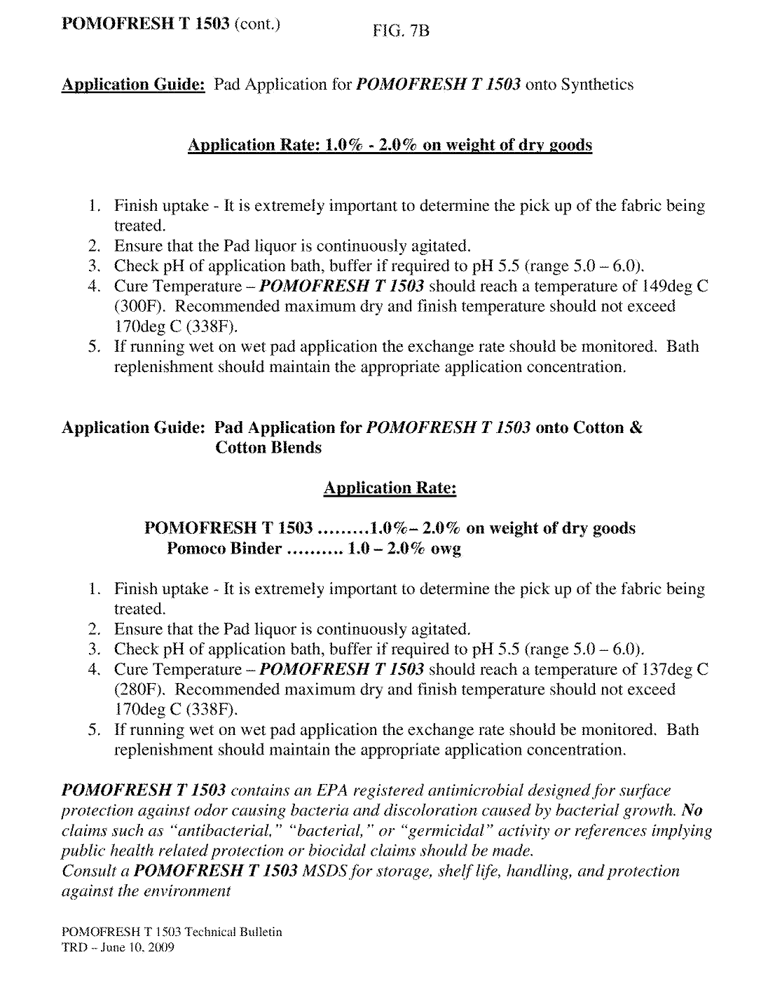

POMOFRESH T 1503 (trademark) is an example product which contains triclosan which can be used at the antibacterial substance applied to the filter media 14. The POMOFRESH T 1503 product is manufactured by Piedmont Chemical Industries I, LLC. See FIG. 6A-FIG. 7B product sheets which provide more information about POMOFRESH T 1503. The POMOFRESH T 1503 product contains approximately 3% triclosan which actively fights the growth of odor causing bacteria, mold, and mildew which significantly improves the freshness and quality of the air passing through the filter assembly 10.

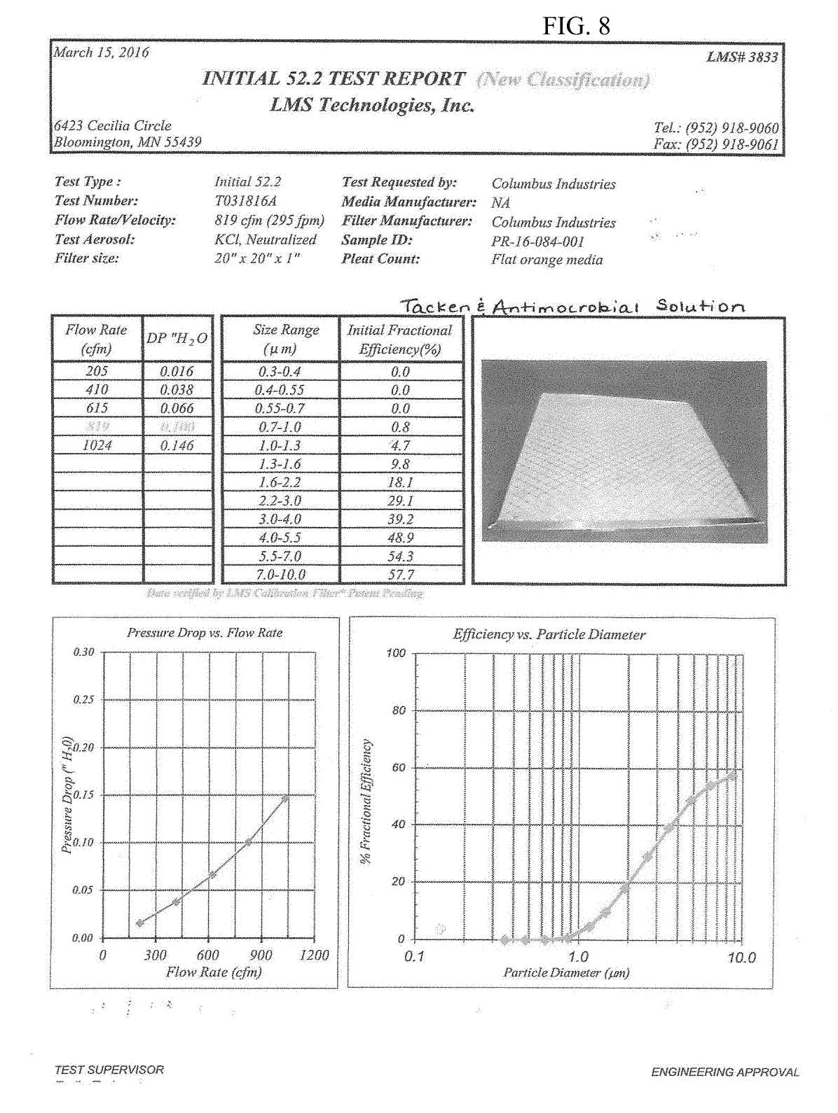

FIG. 8 is a testing and analysis report of a version of the invention. The version tested contained both the tackified layer 30 and the antibacterial/microbial substance containing triclosan. The filter assembly utilized was a 20 in.×20 in.×1 in. The results of the testing and analysis show a robust range of initial fractional efficiency as high as 57.7% which is superior in comparison to the prior art.

Generally, the filter assembly 10 can be made in any manner and of any material chosen with sound engineering judgment. Preferably, materials will be strong, lightweight, long lasting, economic, and ergonomic.

The invention does not require that all the advantageous features and all the advantages need to be incorporated into every version of the invention.

Although preferred embodiments of the invention have been described in considerable detail, other versions and embodiments of the invention are certainly possible. Therefore, the present invention should not be limited to the described embodiments herein.

All features disclosed in this specification including any claims, abstract, and drawings may be replaced by alternative features serving the same, equivalent or similar purpose unless expressly stated otherwise.

1: A filter assembly for removing particles from air flow across the filter assembly from an upstream side to a downstream side, the filter assembly comprising:
(a) a peripheral frame adapted to be supported in communication with an intake opening in a residential return air duct; and
(b) a filter media mourned within the flume for removing particulate from air flowing from the upstream side of the filter assembly to the downstream side of the filter assembly, the downstream side of the filter media comprising a layer of filter media treated with a tackifier material and an antibacterial substance.

2. (canceled)

3: The filter assembly of claim 1, wherein the antibacterial substance contains the organic compound triclosan.

4: The filter assembly of claim 3, wherein the antibacterial substance contains at least 1% triclosan.

5: The filter assembly of claim 4, wherein the layer of filter media treated with a tackifier material is treated with an oil based tackifier material.

6: The filter assembly of claim 5, wherein the filter media is chosen from the group consisting of a synthetic material, polyester material, fiberglass material, carbon material, or hog hair.

7: The filter assembly of claim 1, wherein the layer of filter media treated with a tackifier material is treated with an oil based tackifier material.

8. (canceled)

9. (canceled)

10: The filter assembly of claim 1, wherein the filter media is chosen from the group consisting of a synthetic material, polyester material, fiberglass material, carbon material, or bog hair.

11: A filter assembly for removing particles from air flow across the filter assembly from an upstream side to a downstream side, the filter assembly comprising:
(a) a peripheral frame adapted to be supported in communication with an intake opening in a residential return air duct; and
(b) a synthetic filter media mounted within the frame for removing particulate from air flowing from the upstream side of the filter assembly to the downstream side of the filter assembly, the downstream side of the filter media comprising a layer of filter media treated with an oil based tackifier material and an antibacterial substance, wherein the antibacterial substance contains at least 1% of the organic compound triclosan.
